(19) United States
(12) Patent Application Publication
(10) Pub. No.: US 2009/0260794 A1
(43) Pub. Date: Oct. 22, 2009

(54) Heat Exchanger, Method for Manufacturing the Same, and Heat Exchanging Tube

(75) Inventors: Kazuhiko Minami, Tochigi (JP); Tomoaki Yamanoi, Tochigi (JP); Masahiro Kojima, Tochigi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Showa Denko K.K., Tokyo (JP)

(21) Appl. No.: 10/585,658

(22) PCT Filed: Jan. 7, 2005
(86) PCT No.: PCT/JP05/00433

§ 371 Date: May 26, 2009

Related U.S. Application Data
(60) Provisional application No. 60/537,006, filed on Jan. 20, 2004.

(30) Foreign Application Priority Data
Jan. 9, 2004 (JP) 2004-4542

(51) Int. Cl. F28D 1/053; F28F 1/02; B21D 53/08; F28F 1/20; F16L 9/02

(52) U.S. Cl. 165/182; 29/890.046; 138/177; 228/183

(57) ABSTRACT

The present invention is directed to a method for manufacturing a heat exchanger in which a Zn thermally sprayed layer is formed on a surface of an aluminum flat tube 2 and then the Zn thermally sprayed tube is combined with an aluminum corrugated fin and brazed to the fin. The Zn thermally sprayed tube 2 is subjected to a Zn diffusion treatment by heating the tube before the brazing to diffuse the Zn in the tube surface, and thereafter the brazing is performed. The heat exchanger manufactured in this way can assuredly have a stable sacrifice corrosion layer and is excellent in corrosion resistance. The heat exchanger can be manufactured efficiently without major facility changes at low cost.

### CROSS REFERENCE TO RELATED APPLICATIONS

This application is an application filed under 35 U.S.C. §111(a) claiming the benefit pursuant to 35 U.S.C. §119(e)(1) of the filing date of Provisional Application No. 60/537,006 filed on Jan. 20, 2004, pursuant to 35 U.S.C. §111(b).

This application claims priority to Japanese Patent Application No. 2004-4542 filed on Jan. 9, 2004 and U.S. Provisional Application No. 60/537,006 filed on Jan. 20, 2004, the entire disclosures of which are incorporated herein by reference in their entireties.

### BACKGROUND OF THE INVENTION

1. Field of the Invention

The present invention relates to a heat exchanger in which a sacrifice corrosion layer by Zn thermal spraying was formed on a tube surface, a method of manufacturing the heat exchanger and a tube for use in heat exchangers.

In this disclosure, the wording of “aluminum” is used in the meaning including aluminum and its alloy.

2. Description of the Related Art

The following description sets forth the inventor's knowledge of related art and problems therein and should not be construed as an admission of knowledge in the prior art.

As an aluminum heat exchanger, the so-called multi-flow type or parallel-flow type heat exchanger is well known in which a plurality of flat tubes are arranged in the thickness direction with a fin interposed therebetween and hollow headers are connected to both ends of these tubes in fluid communication. In such heat exchanger, the fin and/or the header, for example, is constituted by an aluminum brazing sheet with clad brazing material. These are simultaneously brazed in a furnace in a provisionally assembled state to thereby integrally secure as a whole.

Furthermore, in an aluminum heat exchanger, in order to secure the corrosion resistance, such as prevention of pore openings (pitting corrosion) in the tube by corrosion, in many cases, technique for forming a sacrifice corrosion layer in which a Zn thermally sprayed layer is formed on the tube surface by diffusing the Zn in the tube surface is used.

Conventionally, if the Zn adhered amount is increased at the time of thermally spraying the Zn on the tube surface, the most of Zn tends to diffuse at the brazing portion (fillet portion) between the tube and the fin. As a result, the fillet will be corroded preferentially, resulting in the so-called fin detachment in which the fin is detached from the tube.

Accordingly, it is preferable to reduce the Zn adhered amount. In this case, however, it becomes difficult to perform a stable thermal spraying of Zn at the lower amount side, resulting in uneven adhered Zn on the tube surface. As a result, Zn adhered portions and Zn non-adhered portions exist on the tube surface, which in turn may cause pitting corrosion in the tube.

Under such a technical background, methods for manufacturing a heat exchanger capable of precisely controlling the Zn adhered amount at the Zn lower adhered amount side have been proposed, in Japanese Unexamined Laid-open Patent Publication No. 4-15496 (Patent Document No. 1) and Japanese Unexamined Laid-open Patent Publication No. 2003-225760 (Patent Document No. 2).

According to the manufacturing method disclosed in Patent Document 1, an aluminum-zinc alloy with the zinc content of 30 to 90 wt % is thermally sprayed on the tube surface to form a Zn thermally sprayed layer thereon. On the other hand, according to the manufacturing method disclosed in the Patent Documents 2, after applying non-corrosive flux showing a zinc substitution reaction on a tube surface, simultaneous integral brazing is performed to replace the zinc in the flux with the aluminum of the tube at the time of the brazing so as to form a Zn diffusion layer in the tube surface.

However, in the manufacturing method of the heat exchanger disclosed in the aforementioned Patent Documents 1, there is a problem that expensive aluminum-Zn alloy to be thermally sprayed causes an increased manufacturing cost. In addition, since aluminum adheres to the tube surface together with Zn by the thermal spraying, the tube thickness increases. Therefore, it is necessary to strictly control the thickness of the thermally sprayed layer with a higher degree of accuracy as compared with a conventional method. In order to maintain such high accuracy, it cannot help decreasing the line velocity at the time of the thermal spray processing, which in turn causes a deterioration of the productive efficiency.

In the manufacturing method of a heat exchanger disclosed in the aforementioned Patent Documents 2, the non-corrosive flux showing a Zn substitution reaction to be applied is expensive, causing an increased manufacturing cost. Furthermore, since resin is contained in the flux as a binder, it is required to heat the binder resin to resolve it at the time of brazing. This causes a complicated temperature administration and a deterioration of the productive efficiency. Moreover, the thermally decomposed resin contaminates the inside of the furnace. To cope with the contamination, it is required to add a special facility to the heating furnace and/or change the heating furnace which will be a major addition and/or change of the heating furnace. Accordingly, in actual, it was very difficult to employ this manufacturing method.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a heat exchanger excellent in corrosion resistance capable of preventing tube pitting corrosion and fin detachment by an assuredly formed stable sacrifice corrosion layer.

Among other potential advantages, some embodiments can provide a method of manufacturing the aforementioned heat exchanger capable of efficiently and economically manufacturing the heat exchanger without requiring major facility changes.

Among other potential advantages, some embodiments can provide a heat exchanging tube for use in the aforementioned heat exchanger.

To achieve the above objects, the present invention provides the following means.

[1] A method of manufacturing an aluminum heat exchanger in which a Zn thermally sprayed layer is formed on a surface of an aluminum flat tube and then the Zn thermally sprayed tube is combined with an aluminum corrugated fin and brazed to the fin,

wherein the Zn thermally sprayed tube is subjected to a Zn diffusion treatment by heating the tube before the brazing to diffuse the Zn in the tube surface, and thereafter the brazing is performed.

In the manufacturing method of an aluminum heat exchanger according to the present invention, since the Zn is diffused in the tube surface by heating the Zn thermally sprayed tube before the brazing, a Zn diffusion layer containing Zn with a uniform concentration distribution can be formed to a prescribed area of the tube surface by the Zn diffusion treatment. Accordingly, the Zn in the Zn diffusion layer will not be excessively diffused in the fillet formed between the tube and the fin at the time of being heated during the subsequent brazing processing. Thus, the thickening of Zn in the fillet can be controlled and therefore Zn can be diffused in the fillet at a moderate concentration. As a result, the corrosion resistance of the fillet can be enhanced and it becomes possible to assuredly prevent fin detachment or the like due to early corrosion of the fillet.

Furthermore, since the Zn diffusion layer contains Zn at a moderate and uniform concentration distribution, based on the diffusion layer, a stable desired sacrifice corrosion layer can be formed assuredly. This improves the corrosion resistance of the tube and therefore an occurrence of defects such as pitting corrosion can be assuredly prevented.

Furthermore, in the present invention, since no thermal spraying of expensive Al—Zn alloy is performed or expensive Zn substitution-reaction type flux is not applied, the manufacturing cost can be reduced.

Furthermore, since Zn is thermally sprayed and then the Zn is heated to be diffused, the Zn diffusion treatment can eliminate uneven Zn adhered amount and the like caused during the thermal spraying, resulting in a Zn diffusion layer having a uniform concentration distribution. In other words, the control of the Zn adhered amount at the time of the Zn thermal spraying can be performed simply and precisely without reducing the line velocity, etc., and therefore the productive efficiency can be improved.

Furthermore, in the present invention, since the flux does not contain binder resin, it is not necessary to decompose the resin during the brazing, and therefore contamination of the furnace due to resin can be prevented. Furthermore, no major change, such as an addition of special equipments for the contamination, is required, and therefore it becomes possible to efficiently manufacture a heat exchanger by using an existing facility.

[2] A method of manufacturing an aluminum heat exchanger as recited in the aforementioned Item [1], wherein an adhered amount of the Zn on the surface of the flat tube is controlled so as to fall within a range of 6 to 12 g/m².

According to this invention, a more stable Zn diffusion layer can be formed, and therefore a more stable sacrifice corrosion layer can be formed, which improves the corrosion resistance more assuredly.

[3] The method of manufacturing an aluminum heat exchanger as recited in the aforementioned Item [1] or [2], wherein an area rate of an area covered with the Zn on the surface of the flat tube is set to 50% or more of the surface of the Zn thermally sprayed tube.

According to this invention, a sufficient Zn diffusion layer can be formed and therefore corrosion resistance can be further improved.

[4] The method of manufacturing an aluminum heat exchanger as recited in any one the aforementioned Items [1] to [3], wherein the Zn diffusion treatment is performed by a heat-treatment of 470 to 620° C.×5 minutes to 10 hours in an inert gas atmosphere.

According to this invention, a more stable Zn diffusion layer can be formed and therefore corrosion resistance can be improved more assuredly.

[5] The method of manufacturing an aluminum heat exchanger as recited in the aforementioned Item [4], wherein the inert gas atmosphere is a nitrogen gas atmosphere.

According to this invention, a more stable Zn diffusion layer can be formed and therefore corrosion resistance can be improved more assuredly.

[6] An aluminum heat exchanger in which a Zn thermally sprayed tube in which a Zn thermally sprayed layer is formed on a surface of an aluminum flat tube is combined with an aluminum corrugated fin and brazed to the fin,

wherein a surface Zn concentration of a flat tube surface portion located at an intermediate position between adjacent tube-fin connected portions is 0.5 to 2.5 mass %, and

wherein a maximum Zn concentration in an eutectic portion of a fillet of the tube-fin connected portion is 1.0 to 3.5 mass %.

This invention specifies an embodiment of an aluminum heat exchanger obtained by the aforementioned manufacturing method according to the invention, and can acquire the same effects as mentioned above.

[7] A tube for use in aluminum heat exchangers,

wherein a Zn diffusion treatment by heating a Zn thermally sprayed tube is executed after forming the Zn thermally sprayed layer on a surface of an aluminum flat tube.

This invention specifies an embodiment of a tube for use in an aluminum heat exchanger obtained by the aforementioned manufacturing method according to the invention, and can acquire the same effects as mentioned above.

[8] The tube for use in aluminum heat exchangers as recited in the aforementioned Item [7], wherein an adhered amount of Zn on a surface of the Zn thermally sprayed tube is set to 6 to 12 g/m².

According to this invention, a more stable sacrifice corrosion layer can be formed and therefore the corrosion resistance can be further improved.

[9] The tube for use in aluminum heat exchangers as recited in the aforementioned Item [8], wherein an area ratio of an area covered with the Zn on the surface of the Zn thermally sprayed tube is set to 50% or more of the surface of the Zn thermally sprayed tube.

According to this invention, a sufficient sacrifice corrosion layer can be formed and therefore corrosion resistance can be improved more assuredly.

As mentioned above, according to the present invention, a more stable sacrifice corrosion layer can be obtained assuredly, and therefore pitting corrosion of the tube and fin detachment can be prevented, resulting in excellent corrosion resistance. Furthermore, there is an effect that a heat exchanger can be manufactured efficiently at low cost without causing major facility changes.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a front view showing an embodiment of a heat exchanger according to the present invention;

FIG. 2 is an enlarged perspective view showing the connecting portion of the fin and the tube and therearound of the heat exchanger of the embodiment;

FIG. 3 is an enlarged front view showing the connecting portion of the fin and the tube and therearound of the heat exchanger of the embodiment; and

FIG. 4 is an enlarged front view showing the fillet formed between the tube and the fin and therearound of the heat exchanger of the embodiment.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

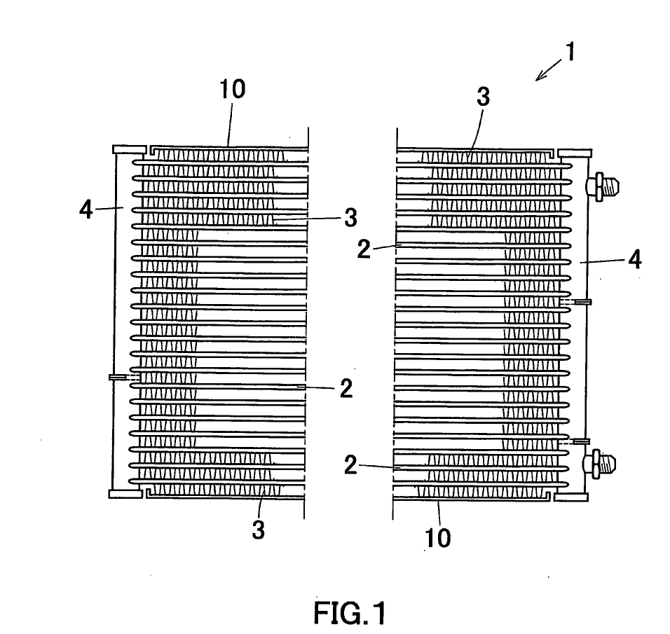

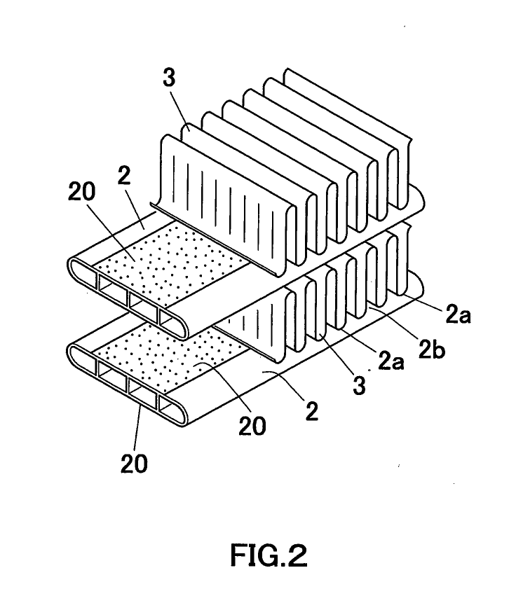

FIG. 1 is a front view showing a heat exchanger according to an embodiment of the present invention. As shown in this figure, this heat exchanger 1 is used as a condenser for use in a refrigeration cycle for automobile air-conditioning systems, and constitutes the so-called multi-flow type heat exchanger.

In detail, this heat exchanger 1 includes a pair of right and left hollow headers 4 and 4 vertically disposed in parallel, a plurality of flat tubes 2 as heat exchanging passages disposed horizontally in parallel between the hollow headers 4 and 4 with the opposite ends thereof connected to the hollow headers 4 and 4 in fluid communication, corrugated fins 3 disposed between adjacent tubes 2 and at the outside of the outermost tubes, and side plates 10 disposed at the outside of the outermost corrugated fins 3 and 3.

In this heat exchanger 1, a Zn diffused tube in which a Zn thermally sprayed on the surface is heated and diffused is used.

Each of the fins 3 and the headers 4 is made of an aluminum brazing sheet in which brazing material is clad on at least one surface thereof. The tubes 2, fins 3, headers 4 and side plates 10 are temporarily combined to form a provisional assemble of a heat exchanger. The provisionally assembled heat exchanger is simultaneously brazed in a furnace to thereby integrally secured.

The Zn diffusion layer 20 formed on the tube 2 is obtained by thermally spraying Zn to the surface of the aluminum core material as a tube member and then by diffusing the Zn in the aluminum core material.

In this embodiment, the method for thermally spraying Zn on the surface of the tube 2 is not limited. However, it is preferable to use an electric-arc-spraying machine. The following methods can be exemplified: a method in which a thermal spraying gun of an electric-arc-spraying machine is moved along a work piece; a method in which spraying is performed while unwinding a coled work; a method in which extruding and thermal spraying are simultaneously performed with a thermal spraying gun disposed immediately after an extrusion die in the case where a work is an extruded member. Especially in the cases where extruding and thermal spraying are performed continuously, productive efficiency can be improved.

The Zn thermally sprayed layer can be formed only on one surface of a work piece, or upper and lower surfaces thereof. Needless to say, in cases where a thermally sprayed layer is formed on both surfaces of a work piece, it is preferable to dispose the spraying gun at upper and lower sides of the work piece.

In this embodiment, the thermal spraying gun of a thermal-spraying machine is disposed at the upper and lower sides of an extrusion opening of an extruder, respectively, and while performing extrusion molding of the flat perforated tube 2 called a harmonica tube by an extruder, thermal spraying of Zn is performed to the upper and lower surfaces of the extruded tube 2 with the thermal spraying gun. Thus, extruding processing and the thermal spraying processing (adhering processing) are carried out continuously.

In this embodiment, it is preferable that the Zn adhered amount to the tube 2 by the thermal-spraying processing falls with in the range of 6 to 12 g/m², more preferably 7 to 10 g/m². That is, if this adhered amount is less than 6 g/m², it becomes difficult to acquire a desired stable sacrifice corrosion layer, which in turn allows an occurrence of pitting corrosion and becomes difficult to obtain good corrosion resistance. On the other hand, if the adhered amount exceeds 12 g/m², it is not preferable because the most of Zn is diffused in the fillet 5 formed between the tube 2 and the fin 3 and a fin detachment occurs due to the preferential corrosion of the fillet 5.

In this embodiment, the Zn adhered amount can be specified by the Zn amount per unit area as follows. That is, the Zn thermally sprayed tube (the amount of Zn contained in the tube is an amount as impurities) is dissolved in acid, and the amount of Zn dissolved is measured by an ICP (Inductively Coupled Plasma) emission spectral analysis method. Then, the dissolved amount of Zn is divided by the external surface area of the dissolved tube to obtain the Zn amount per unit area.

In the tube 2 to which Zn is to be thermally sprayed, it is preferably that the area rate of an area to which Zn is thermally sprayed to the entire tube surfaces is 50% or more, more preferably 60% or more. That is, if the area rate is too small, a non-Zn diffused area increases, resulting in insufficient sacrifice corrosion layer, which in turn becomes difficult to obtain good corrosion resistance due to possible pitting corrosion in the tube 2.

In this embodiment, as mentioned above, the Zn thermally sprayed tube 2 is subjected to a Zn diffusion treatment by heating before the brazing. By this diffusion treatment, Zn diffuses into the tube surface uniformly to thereby form a Zn diffusion layer 20 uniformly containing Zn at a moderate concentration at a prescribed area of the tube surface.

The Zn diffusion treatment is preferably performed under the temperature conditions falling within the range of 470 to 620° C., more preferably 480 to 590° C. within an inert gas atmosphere. That is, if this diffusion temperature is less than 470° C., in order to fully diffuse the Zn, the processing time becomes long, resulting in a deteriorated productive efficiency. On the other hand, if the diffusion temperature exceeds 620° C., the evaporation amount of Zn into the ambient atmosphere increases. This makes it difficult to control the Zn concentration, resulting in insufficient Zn diffusion.

In the Zn diffusion treatment, it is preferable that the diffusion time is 5 minutes to 10 hours, more preferably 5 hours less. That is, if this heating time is less than 5 minutes, it becomes difficult to control the Zn concentration, resulting in insufficient Zn diffusion. To the contrary, if the heating time exceeds 10 hour, the productive efficiency deteriorates due to the long processing time.

The Zn diffusion treatment can be performed in the state of a tube itself or in the state of a provisionally assembled heat exchanger using the Zn thermally sprayed tube 2. In cases where the Zn diffusion treatment is performed in the provisionally assembled state, the Zn diffusion treatment and the subsequent brazing processing can be performed continuously.

Needless to say, in cases where a consecutive processing is performed, it is preferable that the diffusion temperature is set to the melt temperature of the brazing material or below. Furthermore, the diffusion temperature is preferably set to be lower than the temperature at which the flux, which will be mentioned later, activates.

In this embodiment, the tubes 2 to which the Zn diffusion treatment was performed is combined with the hollow headers 4 and 4, the corrugated fins 3 and the side plates 10 to obtain a provisionally assembled heat exchanger. After applying the flux and drying, this provisionally assembled heat exchanger is heated in a nitrogen gas atmosphere furnace, to thereby simultaneously and integrally braze all of the components of the provisionally assembled heat exchanger.

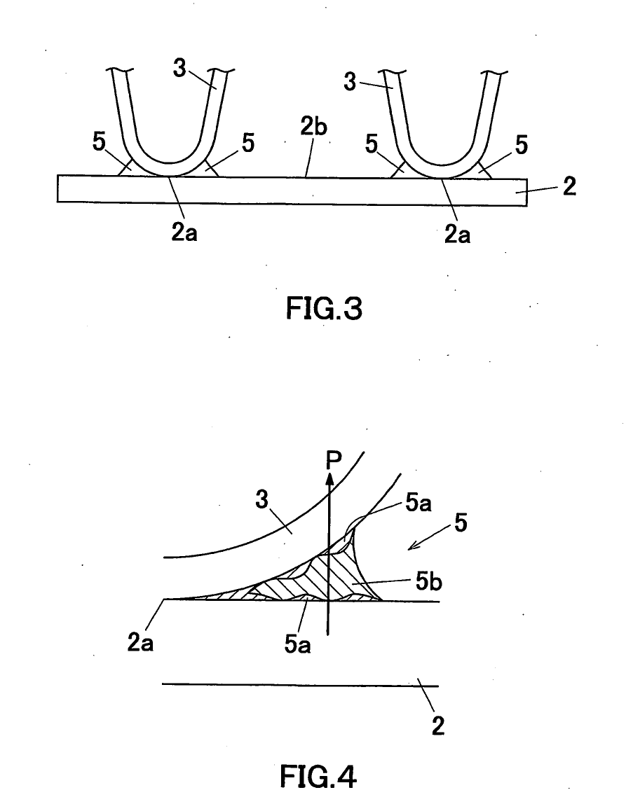

In this brazing processing, as shown in FIGS. 3 and 4, a fillet 5 is formed between the fin 3 and the tube 2 by the brazing material eluted from the corrugated fin 3, whereby the fin and the tube is brazed.

In the fillet 5, a primary-crystalasection 5a is formed at boundary portions with the tube 2 and the fin 3, the Zn is diffused from the Zn diffusion layer 20 of the tube 2 in the fillet intermediate portion, and therefore an eutectic portion 5b of Al—Si is formed.

In this embodiment, it is preferable to adjust the Zn concentration of a predetermined area after the brazing so as to fall within a specific range.

It is preferable to adjust the Zn concentration of the flat tube surface portion (hereinafter referred to as “tube surface Zn concentration”) at the intermediate position between the adjacent joint portions 2a and 2a among the joint portions 2a of the one surface of the tube 2 with the fin 3 (see FIG. 3) as to fall within the range of 0.5 to 2.5 mass %, more preferably 1 to 2 mass %. That is, if the surface Zn concentration is below 0.5 mass %, it becomes difficult to acquire a stable sacrifice corrosion layer, which makes it difficult to obtain good corrosion resistance layer due to possible pitting corrosion in the tube 2. To the contrary, if the surface Zn concentration exceeds 2.5 mass %, the sacrifice corrosion layer dissipates at an early stage, which makes it difficult to maintain sufficient corrosion resistance.

In this embodiment, the tube surface Zn concentration is a Zn concentration measured by irradiating a beam to the position apart from the tube surface layer by 5 μm with an X-ray microanalyser (“EPMA-8705” manufactured by K. K Shimadzu Seisakusyo), and can be specified with the average of the measurements measured at ten arbitrary positions.

Furthermore, as shown in FIG. 4, it is preferable that the maximum Zn concentration of the eutectic portion 5b of the fillet 5 at the joint portion 2a between the tube 2 and the fin 3 (hereinafter referred to as “eutectic portion maximum Zn concentration”) is adjusted so as to fall within the range of 1.0 to 3.5 mass %, more preferably 2 to 3.5 mass %. That is, if the eutectic portion maximum Zn concentration is less than 1.0 mass %, the electric potential of the fillet 5 becomes noble to the fin 3, resulting in preferential corrosion of the fin 3, which make it difficult to obtain good corrosion resistance due to possible fin detachment, etc. On the other hand, if the eutectic portion maximum Zn concentration exceeds 3.5 mass %, the electric potential of the fillet 5 becomes ignoble to the fin 3, resulting in preferential corrosion of the fillet 5, which make it difficult to obtain good corrosion resistance due to possible fin detachment, etc.

In this embodiment, as shown in FIG. 4, the eutectic portion maximum Zn concentration is the maximum Zn concentration obtained by measuring the eutectic portion 5b by a line analysis at 2 μm pitch along the direction of an allow shown in the figure with the aforementioned X-ray microanalyser, and can be specified by the average value of measurements measured at ten arbitrary positions. In this measurement, the portion which can be measured in the longest possible range in the direction of an arrow mark P among eutectic portions 5b is selected as the line analysis part by the EPMA.

In this embodiment, it is preferable that the Zn content of the core material of the fin 3 is 0.8 to 2.6 mass %, more preferably 0.8 to 1.5 mass %. That is, if the Zn content is less than 0.8 mass %, the electric potential of the fin 3 becomes noble to the fillet 5, resulting in preferential corrosion of the fillet 5, which make it difficult to obtain good corrosion resistance due to possible fin detachment, etc. On the other hand, if the Zn content exceeds 2.6 mass %, the electric potential of the fin 3 becomes ignoble to the fillet 5, causing early deterioration of the corrosion resistance of the fin itself, resulting in a deterioration of the heat-conducting performance.

As mentioned above, according to the manufacturing method of the heat exchanger of this embodiment, before the brazing processing, Zn is diffused into the Zn thermally sprayed tube 2 by heating it. Therefore, by the Zn diffusion treatment, a Zn diffusion layer 20 in which Zn is contained at a uniform concentration distribution in a prescribed area of the surface of the tube can be formed. Accordingly, when heated during the subsequent brazing processing, the Zn in the Zn diffusion layer 20 is not superfluously diffused in the fillet 5 between the tube 2 and the fin 3. Thus, thickening of Zn in the fillet 5 can be prevented and Zn can be diffused in the fillet 5 at a moderate concentration. As a result, the corrosion resistance of the fillet 5 can be improved, which in turn can assuredly prevent fin detachment or the like due to early corrosion of the fillet 5.

Furthermore, since the Zn diffusion layer 20 contains Zn at a moderate and uniform concentration distribution, based on the diffusion layer 20, a prescribed stable sacrifice corrosion layer can be formed assuredly, resulting in improved corrosion resistance of the tube 2, which in turn can assuredly prevent an occurrence of defects such as pitting corrosion.

In the manufacturing method of this embodiment, since no thermal spraying of expensive Al—Zn alloy is performed or expensive Zn substitution-reaction type flux is not applied, the manufacturing cost can be reduced.

Furthermore, since Zn is thermally sprayed and then the Zn is heated to be diffused, the Zn diffusion treatment can eliminate uneven Zn adhered amount and the like caused during the thermal spraying, resulting in a Zn diffusion layer having a uniform concentration distribution. In other words, the control of the Zn adhered amount at the time of the Zn thermal spraying can be performed simply and precisely without reducing the line velocity, etc., and therefore the productive efficiency can be improved.

Furthermore, in the present invention, since the flux does not contain binder resin, it is not necessary to decompose the resin during the brazing, and therefore contamination of the furnace due to resin can be prevented. Furthermore, no major change, such as an addition of special equipments for the contamination, is required, and therefore it becomes possible to efficiently manufacture a heat exchanger by using an existing facility.

### EXAMPLES

Hereinafter, Examples related to the present invention and Comparative Examples for verifying results of Examples will be explained.

### Example 1

Using extruded material made of Al alloy (0.4 wt % Cu-0.15 wt % Mn-balance being aluminum), a flat multi-bored tube with a width of 16 mm, a height of 3 mm and a wall thickness of 0.5 mm was extruded with an extruder. On the other hand, a thermal spraying gun of an electric-arc-spraying machine was disposed above and below the extruder outlet to thermally spray Zn to the upper and lower surfaces of the extruded tube to thereby form a Zn thermally sprayed layer.

At this time, as shown in the Table 1, the Zn adhered amount in the Zn thermal spraying processing was adjusted to 6 g/m², and the area rate to the entire tube surface was adjusted to 60%. Subsequently, this Zn thermally sprayed tube 2 was subjected to a Zn diffusion treatment of the Zn thermally sprayed-layer under the heating conditions of 480° C.×2 hours in a furnace of a nitrogen atmosphere. Thus, a Zn diffusion layer 20 was formed.

Using these tubes 20, a heat exchanger having the same structure as that of the multi-flow type heat exchanger (see FIG. 1) of the aforementioned embodiment was provisionally assembled.

Then, the suspension in which flux is suspended in water was applied to the heat-exchanger provisional assembly with a spray, and then dried. Thereafter, the assembly was brazed under the heating condition of 600° C.×10 minutes in a nitrogen atmosphere furnace to integrally secure the entire assembly. Thus, an aluminum heat exchanger was produced.

In this heat exchanger, the Zn concentration was measured based on the measuring method of the aforementioned embodiment. As a result, as shown in Table 1, the Zn concentration of the surface between fins was 1.2 mass %, and the maximum Zn concentration of the fillet eutectic portion was 19 mass %.

Furthermore, to this heat exchanger, the following CCT and SWAAT tests were performed, and corrosion condition was also observed.

### <CCT (Combined Cycle Corrosion Test)>

Processing including spraying corrosion-test liquid consisting of 5% NaCl water solution for 1 hour, drying for 2 hours, and leaving the test piece in a wet condition for 21 hours, which consists one cycle, was performed by 180 cycles.

Thereafter, the maximum corrosion depth of each test piece was measured, and the results are shown as follows:

“⊚” the maximum corrosion depth was less than 150 μm;
“◯”: the maximum corrosion depth exceeded 150 μm, but less than 200 μm;
“Δ”: the maximum corrosion depth exceeded 250 μm but less than 250 μm; and
“X”: the maximum corrosion depth exceeded 250 μm.

The results are collectively shown in the following table 1.

### <SWAAT (Synthetic Sea Water Acetic Acid Salt Spray Test)>

A cycle of spraying corrosion-test liquid by ASTM D1141 for 0.5 hours and leaving the test piece for 1.5 hours in a wet condition was repeated for 960 hours.

The fin joint remained ratio of each test piece after corrosion test was measured, the results are shown as follows.

“⊚”: the fin joint remained ratio after a corrosion test was 95% or more;
“◯”: the fin joint remained ratios after the corrosion test was 70% or more but less than 95%;
“Δ”: the fin joint remained ratios after the corrosion test was 50% or more but less than 70%; and

“X”: the fin joint remained ratios after the corrosion test was less than 50%.

The results are collectively shown in the following table 1. The fin joint remained ratio after the corrosion test is shown by a rate that the tube and the fin of the test piece after the corrosion test are joined by percentage.

TABLE 1

| | Zn thermal-spraying | | | | | Maximum Zn | | |
|---|---|---|---|---|---|---|---|---|
| | processing | | Zn diffusion processing | | Surface Zn | concentration of | | |
| | Zn adhered | | Diffusion | Diffusion | concentration | fillet eutectic | | |
| | amount | Area rate | temperature | time | between fins | portion | CCT | SWAAT |
| | (g/m²) | (%) | (° C.) | (Minutes) | (mass %) | (mass %) | result | result |
| Example 1 | 6 | 60 | 480 | 120 | 1.2 | 1.9 | ◯ | ⊚ |
| Example 2 | 7 | 65 | 480 | 120 | 1.5 | 2.3 | ⊚ | ⊚ |
| Example 3 | 8 | 70 | 480 | 120 | 1.6 | 2.5 | ⊚ | ⊚ |
| Example 4 | 9 | 60 | 480 | 120 | 1.7 | 2.8 | ⊚ | ⊚ |
| Example 5 | 10 | 60 | 480 | 120 | 1.8 | 2.9 | ⊚ | ⊚ |
| Example 6 | 12 | 50 | 480 | 120 | 2.3 | 3.4 | ⊚ | ◯ |
| Comp. Ex. 1 | 5 | 60 | 480 | 120 | 1.0 | 1.7 | Δ | ⊚ |
| Comp. Ex. 2 | 13 | 60 | 480 | 120 | 2.5 | 4.0 | ⊚ | Δ |
| Comp. Ex. 3 | 10 | 30 | 480 | 120 | 1.4 | 2.7 | Δ | ◯ |

### Example 2

As shown in Table 1, the adhered amount by the Zn thermal-spraying processing was set to 7 g/m² and the area rate was set to 65%. Diffusion processing and brazing processing were performed in the same manner as mentioned above, and the Zn concentration of the surface between fins and the maximum Zn concentration of the fillet eutectic portion were measured, and the same test was performed.

### Example 3

As shown in Table 1, the adhered amount by the Zn thermal-spraying processing was set to 8 g/m² and the area rate was set to 70%. Diffusion processing and brazing processing were performed in the same manner as mentioned above, and the Zn concentration of the surface between fins and the maximum Zn concentration of the fillet eutectic portion were measured, and the same test was performed.

### Example 4

As shown in Table 1, the adhered amount by the Zn thermal-spraying processing was set to 9 g/m² and the area rate was set to 60%. Diffusion processing and brazing processing were performed in the same manner as mentioned above, and the Zn concentration of the surface between fins and the maximum Zn concentration of the fillet eutectic portion were measured, and the same test was performed.

### Example 5

As shown in Table 1, the adhered amount by the Zn thermal-spraying processing was set to 10 g/m² and the area rate was set to 60%. Diffusion processing and brazing processing were performed in the same manner as mentioned above, and the Zn concentration of the surface between fins and the maximum Zn concentration of the fillet eutectic portion were measured, and the same test was performed.

### Example 6

As shown in Table 1, the adhered amount by the Zn thermal-spraying processing was set to 12 g/m² and the area rate was set to 50%. Diffusion processing and brazing processing were performed in the same manner as mentioned above, and the Zn concentration of the surface between fins and the maximum Zn concentration of the fillet eutectic portion were measured, and the same test was performed.

### Comparative Example 1

As shown in Table 1, the same processing as in Example 1 was performed except that the adhered amount in the Zn thermal-spraying processing was made as excessively low as 5 g/m².

### Comparative Example 2

As shown in Table 1, the same processing as in Example 1 was performed except that the adhered amount in the Zn thermal-spraying processing was made as excessively low as 13 g/m².

### Comparative Example 3

As shown in Table 1, the same processing as in Example 1 was performed except that the Zn area rate in the Zn thermal-spraying processing was made as excessively low as 30%.

### <Evaluation>

As will be apparent from Table 1, in the heat exchanger of Examples 1 to 6 relevant to the present invention, in CCT and SWAAT, satisfactory results were obtained and the results reveals that it is excellent in corrosion resistance. In cases where the adhered amount was 7 to 10, like in Examples 2 to 5, it had further excellent corrosion resistance.

To the contrary, in the heat exchangers of Comparative Examples 1 to 3, it was somewhat inferior in corrosion resistance.

### Example 7

As shown in Table 2, brazing processing was performed in the same manner as in Example 1 except that the Zn thermally sprayed tube with the Zn adhered amount of 10 g/m² and the area rates of 60% was subjected to the Zn diffusion treatment under the heating conditions for 470° C.×600 minutes. And the Zn concentration of the surface between fins and the maximum Zn concentration of the fillet eutectic portion were measured, and the same tests were performed.

TABLE 2

| | Zn thermal-spraying | | | | | Maximum Zn | | |
|---|---|---|---|---|---|---|---|---|
| | processing | | Zn diffusion processing | | Surface Zn | concentration of | | |
| | Zn adhered | | Diffusion | Diffusion | concentration | fillet eutectic | | |
| | amount | Area rate | temperature | time | between fins | portion | CCT | SWAAT |
| | (g/m²) | (%) | (° C.) | (Minutes) | (mass %) | (mass %) | result | result |
| Example 7 | 10 | 60 | 470 | 600 | 1.4 | 2.0 | ⊚ | ⊚ |
| Example 8 | 10 | 60 | 480 | 540 | 1.3 | 2.0 | ⊚ | ⊚ |
| Example 9 | 10 | 60 | 500 | 480 | 1.0 | 1.9 | ⊚ | ⊚ |
| Example 10 | 10 | 60 | 500 | 420 | 1.0 | 1.8 | ⊚ | ⊚ |
| Example 11 | 10 | 60 | 550 | 360 | 0.7 | 1.4 | ◯ | ⊚ |
| Example 12 | 10 | 60 | 550 | 240 | 0.9 | 1.5 | ⊚ | ⊚ |
| Example 13 | 10 | 60 | 580 | 180 | 0.8 | 1.5 | ◯ | ⊚ |
| Example 14 | 10 | 60 | 580 | 60 | 1.0 | 1.9 | ⊚ | ⊚ |
| Example 15 | 10 | 60 | 600 | 30 | 1.0 | 2.0 | ⊚ | ⊚ |
| Example 16 | 10 | 60 | 610 | 10 | 1.2 | 2.2 | ⊚ | ⊚ |
| Example 17 | 10 | 60 | 620 | 5 | 1.3 | 2.3 | ⊚ | ◯ |
| Comp. Ex. 4 | 10 | 60 | — | — | 2.8 | 5.0 | ⊚ | X |
| Comp. Ex. 5 | 10 | 60 | 450 | 120 | 2.5 | 4.0 | ⊚ | Δ |
| Comp. Ex. 6 | 10 | 60 | 630 | 120 | 0.4 | 0.9 | Δ | ⊚ |

### Example 8

As shown in Table 2, the same processing as in Example 7 was performed except that the heating conditions of the Zn diffusion treatment were set to 480° C.×540 minutes.

### Example 9

As shown in Table 2, the same processing as in Example 7 was performed except that the heating conditions of the Zn diffusion treatment were set to 500° C.×480 minutes.

### Example 10

As shown in Table 2, the same processing as in Example 7 was performed except that the heating conditions of the Zn diffusion treatment were set to 500° C.×420 minutes.

### Example 11

As shown in Table 2, the same processing as in Example 7 was performed except that the heating conditions of the Zn diffusion treatment were set to 550° C.×360 minutes.

### Example 12

As shown in Table 2, the same processing as in Example 7 was performed except that the heating conditions of the Zn diffusion treatment were set to 550° C.×240 minutes.

### Example 13

As shown in Table 2, the same processing as in Example 7 was performed except that the heating conditions of the Zn diffusion treatment were set to 580° C.×180 minutes.

### Example 14

As shown in Table 2, the same processing as in Example 7 was performed except that the heating conditions of the Zn diffusion treatment were set to 580° C.×60 minutes.

### Example 15

As shown in Table 2, the same processing as in Example 7 was performed except that the heating conditions of the Zn diffusion treatment were set to 600° C.×30 minutes.

### Example 16

As shown in Table 2, the same processing as in Example 7 was performed except that the heating conditions of the Zn diffusion treatment were set to 610° C.×10 minutes.

### Example 17

As shown in Table 2, the same processing as in Example 7 was performed except that the heating conditions of the Zn diffusion treatment were set to 620° C.×5 minutes.

### Comparative Example 4

As shown in Table 2, the same processing as in Example 7 was performed except that the Zn diffusion treatment was not performed.

### Comparative Example 5

As shown in Table 2, the same processing as in Example 7 was performed except that the heating conditions of the Zn diffusion treatment were set to 450° C.×120 minutes.

### Comparative Example 6

As shown in Table 2, the same processing as in Example 7 was performed except that the heating conditions of the Zn diffusion treatment were set to 630° C.×120 minutes.

### <Evaluation 2>

As will be apparent from Table 1, in the heat exchangers of Examples 7 to 17 relevant to the present invention, in CCT and SWAAT, satisfactory results were obtained and the results reveals that they are excellent in corrosion resistance.

To the contrary, in the heat exchangers of Comparative Examples 5 and 6, it was somewhat inferior in corrosion resistance. A satisfactory result could not be obtained, and it was apparent that the corrosion resistance was poor.

### INDUSTRIAL APPLICABILITY

This invention can be applied to a heat exchanger in which a Zn thermally sprayed sacrifice corrosion layer is formed on a tube surface, and the manufacturing method thereof, a tube for use in such heat exchanger.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” is meant as a non-specific, general reference and may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A method of manufacturing an aluminum heat exchanger in which a Zn thermally sprayed layer is formed on a surface of an aluminum flat tube and then the Zn thermally sprayed tube is combined with an aluminum corrugated fin and brazed to the fin,
wherein the Zn thermally sprayed tube is subjected to a Zn diffusion treatment by heating the tube before the brazing to diffuse the Zn in the tube surface, and thereafter the brazing is performed.

2. The method of manufacturing an aluminum heat exchanger as recited in claim 1, wherein an adhered amount of the Zn on the surface of the flat tube is controlled so as to fall within a range of 6 to 12 g/m².

3. The method of manufacturing an aluminum heat exchanger as recited in claim 1, wherein an area rate of an area covered with the Zn on the surface of the flat tube is set to 50% or more of the surface of the Zn thermally sprayed tube.

4. The method of manufacturing an aluminum heat exchanger as recited in claim 1, wherein the Zn diffusion treatment is performed by a heat-treatment of 470 to 620° C.×5 minutes to 10 hours in an inert gas atmosphere.

5. The method of manufacturing an aluminum heat exchanger as recited in claim 4, wherein the inert gas atmosphere is a nitrogen gas atmosphere.

6. An aluminum heat exchanger in which a Zn thermally sprayed tube in which a Zn thermally sprayed layer is formed on a surface of an aluminum flat tube is combined with an aluminum corrugated fin and brazed to the fin,
wherein a surface Zn concentration of a flat tube surface portion located at an intermediate position between adjacent tube-fin connected portions is 0.5 to 2.5 mass %, and
wherein a maximum Zn concentration in an eutectic portion of a fillet of the tube-fin connected portion is 1.0 to 3.5 mass %.

7. A tube for use in aluminum num heat exchangers,
wherein a Zn diffusion treatment by heating a Zn thermally sprayed tube is executed after forming the Zn thermally sprayed layer on a surface of an aluminum flat tube.

8. The tube for use in aluminum num heat exchangers as recited in claim 7, wherein an adhered amount of Zn on a surface of the Zn thermally sprayed tube is set to 6 to 12 g/m².

9. The tube for use in aluminum num heat exchangers as recited in claim 8, wherein an area ratio of an area covered with the Zn on the surface of the Zn Thermally Sprayed Tube is set to 50% or more of the surface of the Zn thermally sprayed tube.
